(19) United States
(12) Patent Application Publication
(10) Pub. No.: US 2024/0041563 A1
(43) Pub. Date: Feb. 8, 2024

(54) TOOTH MOVEMENT CONTROL BASED ON SURFACE ENGAGEMENT

(71) Applicant: SDC U.S. SmilePay SPV, Nashville, TN (US)

(72) Inventors: Tim Wucher, Windhoek (NA); Drew Marschner, Nashville, TN (US)

(73) Assignee: SDC U.S. SmilePay SPV, Nashville, TN (US)

(21) Appl. No.: 17/882,201

(22) Filed: Aug. 5, 2022

(51) Int. Cl. A61C 7/00; A61C 13/34

(52) U.S. Cl. CPC A61C 7/002; A61C 13/34

(57) ABSTRACT

A method includes receiving a digital model of a dentition comprising at least one tooth comprising a plurality of tooth faces, determining a factor of engagement for each of the plurality of tooth faces, determining an addressable area of the at least one tooth based on the factors of engagement of the plurality of tooth faces, identifying an area of engagement of the at least one tooth where the area of engagement comprises at least a portion of the addressable area and where the portion comprises at least one tooth face accessible by a dental appliance to apply a force to the at least one tooth to effectuate the movement, and outputting a controllability score for the at least one tooth based on the area of engagement.

### TECHNICAL FIELD

The present disclosure relates generally to the field of dental treatment planning, and more specifically, to systems and methods for determining controllability of a tooth movement.

### BACKGROUND

Dental appliances, such as retainers, braces, and aligners, can be used to adjust positions and orientations of a patient's teeth. The dental appliances are typically designed to move the teeth according to a treatment plan. However, the dental appliances are susceptible to various factors that cause the dental appliance to move the teeth to positions that were not specified in the treatment plan. Additionally, accurate location of the teeth is required for predictable movement, which is conventionally addressed by bonding brackets or tooth attachments, both of which require multiple inconvenient in-person visits. The brackets and tooth attachments are often viewed as not aesthetically pleasing and removal of the brackets and tooth attachments may result in visible and/or permanent damage to the enamel of the teeth. Current clear aligner technology is much less accurate (e.g., less than 50% accurate) than the traditional brackets and tooth attachments, which is why brackets and tooth attachments are sometimes recommended for treatment.

### SUMMARY

In one embodiment, this disclosure is directed to a method. The method includes receiving, by one or more processors, a digital model of a dentition where the digital model comprises at least one tooth comprising a plurality of tooth faces. The method further includes determining, by the one or more processors, a factor of engagement for each of the plurality of tooth faces based on a degree of normality of each tooth face with respect to a direction of a movement for the at least one tooth. The method further includes determining, by the one or more processors, an addressable area of the at least one tooth based on the factors of engagement of the plurality of tooth faces. The addressable area comprises at least one of the plurality of tooth faces. The factor of engagement for each tooth face in the at least one of the plurality of tooth faces satisfies a threshold. The method further includes identifying, by the one or more processors, an area of engagement of the at least one tooth. The area of engagement comprises at least a portion of the addressable area. The portion comprises at least one tooth face accessible by a dental appliance to apply a force to the at least one tooth to effectuate the movement. The method further includes outputting, by the one or more processors, a controllability score for the at least one tooth based on the area of engagement.

In another embodiment, this disclosure is directed to a method. The method includes identifying, by one or more processors, an area of engagement of at least one tooth represented in a digital model of a dentition for applying a first force to move the at least one tooth according to a first movement as part of a treatment plan or a second force to move the at least one tooth according to a second movement as part of the treatment plan. The treatment plan is configured to move the at least one tooth from an initial position to a final position. The area of engagement comprises a portion of the at least one tooth that is capable of engaging with a dental aligner. The dental aligner is to be manufactured to apply the first force or the second force to the at least one tooth via the area of engagement to move the at least one tooth. The method further includes determining, by the one or more processors, a first controllability score for the first movement and a second controllability score for the second movement based on the area of engagement. The first force is associated with the first movement and the second force is associated with the second movement. The method further includes selecting, by the one or more processors, the first movement for the treatment plan based on the first controllability score and the second controllability score.

In another embodiment, this disclosure is directed to a system. The system includes one or more processors and a memory coupled with the one or more processors where the memory stores instructions that, when executed by the one or more processors, cause the one or more processors to identify an area of engagement of at least one tooth represented in a digital model of a dentition for applying a first force to move the at least one tooth according to a first movement as part of a treatment plan or a second force to move the at least one tooth according to a second movement as part of the treatment plan. The treatment plan is configured to move the at least one tooth from an initial position to a final position. The area of engagement comprises a portion of the at least one tooth that is capable of engaging with a dental aligner to be manufactured to apply the first force or the second force to the at least one tooth via the area of engagement to move the at least one tooth. The memory further stores instructions that, when executed by the one or more processors, cause the one or more processors to determine a first controllability score for the first movement and a second controllability score for the second movement based on the area of engagement. The first force is associated with the first movement and the second force is associated with the second movement. The memory further stores instructions that, when executed by the one or more processors, cause the one or more processors to select the first movement for the treatment plan based on the first controllability score and the second controllability score.

Various other embodiments and aspects of the disclosure will become apparent based on the drawings and detailed description of the following disclosure.

### BRIEF DESCRIPTION OF THE DRAWINGS

FIG. 1 shows a schematic diagram of a system for tooth control analysis, according to an illustrative embodiment.

FIG. 2A shows a digital model of a dentition, according to an illustrative embodiment.

FIG. 2B shows teeth of the digital model of FIG. 2A having a tooth mesh, according to an illustrative embodiment.

FIG. 3 shows a tooth model of an initial position of teeth of a dentition, according to an illustrative embodiment.

FIG. 4 shows an illustration of a tooth with tooth faces, according to an illustrative embodiment.

FIGS. 5A-5C shows digital tooth models of a dentition, according to illustrative embodiments.

FIG. 6 shows a digital tooth model of a dentition, according to an illustrative embodiment.

FIG. 7 shows a digital tooth model of a dentition, according to an illustrative embodiment.

FIGS. 8A-8B show digital tooth models of a dentition, according to illustrative embodiments.

FIGS. 9A-9B show digital tooth models of a dentition, according to illustrative embodiments.

FIG. 10 shows a diagram of a method of determining tooth control, according to an illustrative embodiment.

FIG. 11 shows a diagram of a method of generating a treatment plan, according to an illustrative embodiment.

### DETAILED DESCRIPTION

Before turning to the figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, described herein are systems and methods for determining a controllability of a tooth movement for purposes of planning orthodontic treatment. For example, a digital model of a dentition may include at least one tooth. The tooth can have a tooth mesh that defines a plurality of tooth faces. Based on a desired movement of the tooth, a factor of engagement can be determined for each tooth face. The factor of engagement can identify an ability of the tooth face to receive a force that would facilitate the desired movement. For example, when pushing a tooth in a lingual direction, a tooth face on the front of the tooth will have a higher factor of engagement than a tooth face on a side or a back of the tooth. After determining which tooth faces can receive a force, an addressable area is determined. The addressable area can include the tooth faces that are accessible to be contacted by a dental appliance (e.g., not covered by the gingiva or blocked by an adjacent tooth). Then, based on a geometry of the dental appliance, an area of engagement may be determined. The area of engagement may identify a portion of the addressable area that the dental appliance actually contacts. With the area of engagement, a controllability score for the tooth being moved can be calculated. The controllability score can identify the ability of the dental appliance to control the movement of the tooth. The controllability score can be based, at least partially, on the area of engagement (e.g., the larger the area of engagement, the greater the controllability score). The controllability score can be compared to a threshold score to determine if the tooth is controllable enough to actually perform the orthodontic treatment. Various controllability scores can be obtained for various movements to identify the movements with the highest controllability, and to establish the treatment plans with the best controllability. The controllability may be correlated with a predictability of the dental appliance to complete the treatment successfully.

The technical solutions of the systems and methods disclosed herein improve the technical field of orthodontic treatment by improving control and predictability of repositioning teeth via a dental appliance. Control and predictability may be based on type and level of engagement between the dental appliance and the teeth being moved. The type and level of engagement may be based on tooth geometry, appliance geometry, appliance material, intended direction of tooth movement, among others. Improving the control and predictability does not require addition of other attachments or features, but instead focuses on the surface engagement between the tooth and the dental appliance. The technical solutions disclosed herein optimize a surface of a dental appliance rather than add attachments or other features to assist in the repositioning of the teeth. For example, the systems and methods disclosed here prioritize sequencing of tooth movements based on available areas of control. For example, a mesio-distal movement may be prioritized before a labio-lingual alignment due to a higher area of control of the mesio-distal movement before labio-lingual alignment. Similarly, if a movement is desired but there is not enough engagement between the tooth and the dental appliance, a first movement may be performed in order to increase the engagement between the tooth and the dental appliance for the other movement. The technical solutions disclosed herein may also facilitate prediction of uncontrolled tipping of teeth based on the available areas of control to which forces can be applied. For example, if the only available areas of the tooth are near a top of the occlusal surface and there aren't any corresponding areas on the other side of the tooth to create a moment, there could be uncontrolled tipping of the tooth, which may be undesirable.

Additional benefits of the technical solutions disclosed herein include, but are not limited to, precisely characterizing treatment difficulty and assessing efficacy of different aligner designs. The solutions disclosed herein improve control of teeth during a repositioning based solely on the shape of the inner surface of a dental appliance. The solution does not rely on additional attachments or other features to increase the controllability of a tooth. By scoring the movements, the solution can improve or optimize an orthodontic treatment plan based on the most controllable and most predictable movements. By identifying the controllability of a tooth movement, and therefore determining a predictability of the tooth movement, a treatment plan can be generated with more confidence that the tooth/teeth will be moved to the desired positions. The geometry of a dental aligner can be designed based on this analysis to ensure proper contact with the desired areas of the teeth to facilitate the desired movement and reduce unwanted movement.

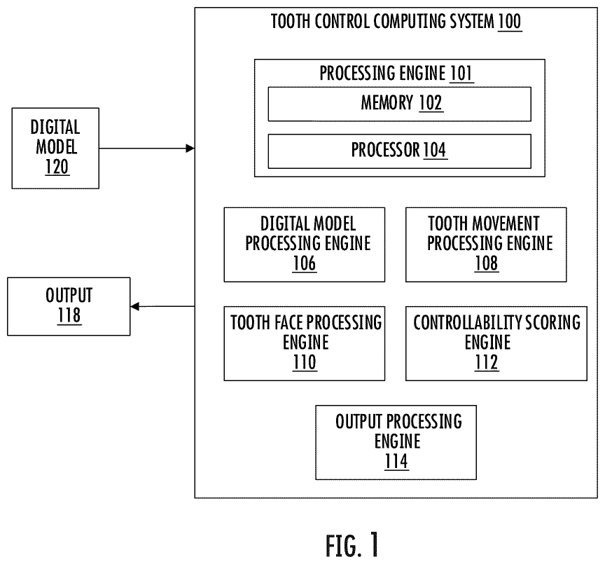

Referring to FIG. 1, a tooth control computing system 100 for determining a controllability of a patient's tooth when undergoing a treatment plan is shown, according to an exemplary embodiment. The tooth control computing system 100 is shown to include a processing engine 101. Processing engine 101 may include a memory 102 and a processor 104. The memory 102 (e.g., memory, memory unit, storage device) may include one or more devices (e.g., RAM, ROM, EPROM, EEPROM, optical disk storage, magnetic disk storage or other magnetic storage devices, flash memory, hard disk storage, or any other medium) for storing data and/or computer code for completing or facilitating the various processes, layers, and circuits described in the present disclosure. The memory 102 may be or include transitory memory or non-transitory memory, and may include database components, object code components, script components, or any other type of information structure for supporting the various activities and information structures described in the present disclosure. According to an illustrative embodiment, the memory 102 is communicably connected with the processor 104 and includes computer code for executing (e.g., by the processor 104) the processes described herein.

The processor 104 may be a general purpose single-chip or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor or any conventional processor, controller, microcontroller, or state machine. The processor 104 may also be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

The tooth control computing system 100 may include various modules or be comprised of a system of processing engines. The processing engine 101 may be configured to implement the instructions and/or commands described herein with respect to the processing engines. The processing engines may be or include any device(s), component(s), circuit(s), or other combination of hardware components designed or implemented to receive inputs for and/or automatically generate outputs based on an initial digital representation of an intraoral device. As shown in FIG. 1, in some embodiments, the tooth control computing system 100 may include a digital model processing engine 106, a tooth movement processing engine 108, a tooth face processing engine 110, a controllability scoring engine 112, and an output processing engine 114. While these engines 106-114 are shown in FIG. 1, it is noted that the tooth control computing system 100 may include any number of processing engines, including additional engines which may be incorporated into, supplement, or replace one or more of the engines shown in FIG. 1.

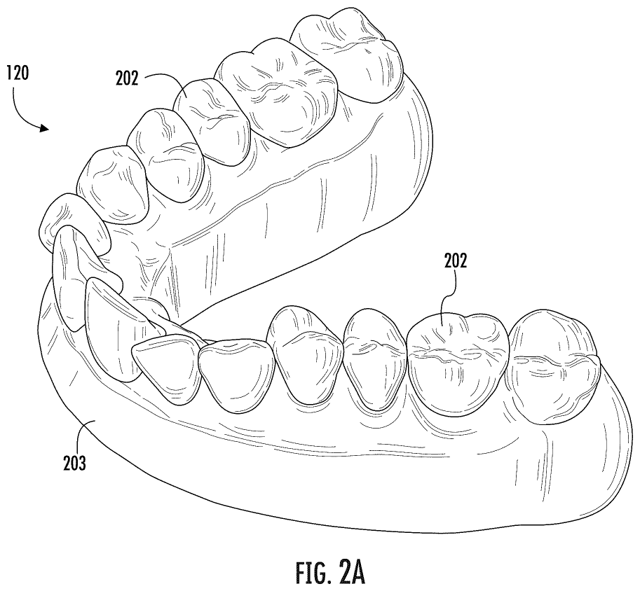

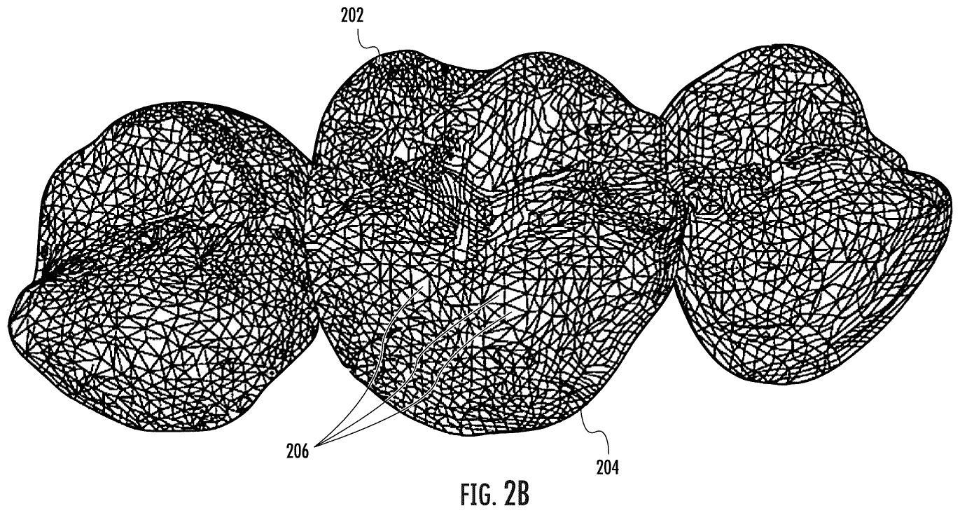

Referring now to FIG. 1, FIG. 2A, and FIG. 2B, tooth control computing system 100 may be configured to receive a digital model 120 (e.g., a 3D digital model). The digital model 120 may be of a dentition or a dental appliance, among others. For example, the digital model processing engine 106 may receive the digital model 120. For example, the digital model processing engine 106 may receive a 3D scan of a patient's dentition. In some embodiments, the digital model processing engine 106 may be configured to generate a digital model of a dentition. For example, the digital model processing engine 106 may receive 2D images of a patient's dentition and be configured to take data from the 2D image and generate a 3D digital model. The digital model 120 of a dentition may include at least one tooth 202. The tooth 202 may be representative of a patient's tooth. The digital model 120 may include a plurality of teeth 202. For example, the digital model 120 may include the patient's whole dentition and include all of the patient's teeth. In some embodiments, the digital model 120 of the dentition may include a subset of all of the patient's teeth (e.g., the bottom teeth of the dentition). The digital model 120 may also include a gingiva 203.

The tooth 202 of the digital model 120 may have a tooth mesh 204. The digital model processing engine 106 may be configured to generate the tooth mesh 204. The tooth mesh 204 can have a plurality of vertices, edges, and faces to define a geometry of the tooth 202. For example, the tooth mesh 204 can be a tessellated tooth mesh defining a plurality of tooth faces 206. The plurality of tooth faces 206 may be small, easy-to-analyze pieces of the 3D tooth 202. The tooth faces 206 can all have the same shape (e.g., a plurality of triangles) or the tooth faces 206 can have different shapes. The tooth faces 206 can all have the same size or can be different sizes. The size and shape of the tooth faces 206 can be based on a geometry of the tooth 202. The digital model processing engine 106 may be configured to analyze each of the tooth faces 206 separately. Each tooth face 206 may comprise data associated with that portion of the tooth 202. For example, a first tooth face 206 may have a first orientation and a second tooth face 206 may have a second orientation. The first tooth face 206 may have a smooth surface and the second tooth face may have a rough surface. The digital model processing engine 106 may identify characteristics or properties of each tooth face 206. The identified characteristics may be applied to the systems and methods disclosed herein for further analysis and computations. For example, as described in more detail below, the tooth control computing system 100 may be able to apply an orientation of a tooth face 206 to facilitate a determination of a controllability of the corresponding tooth 202.

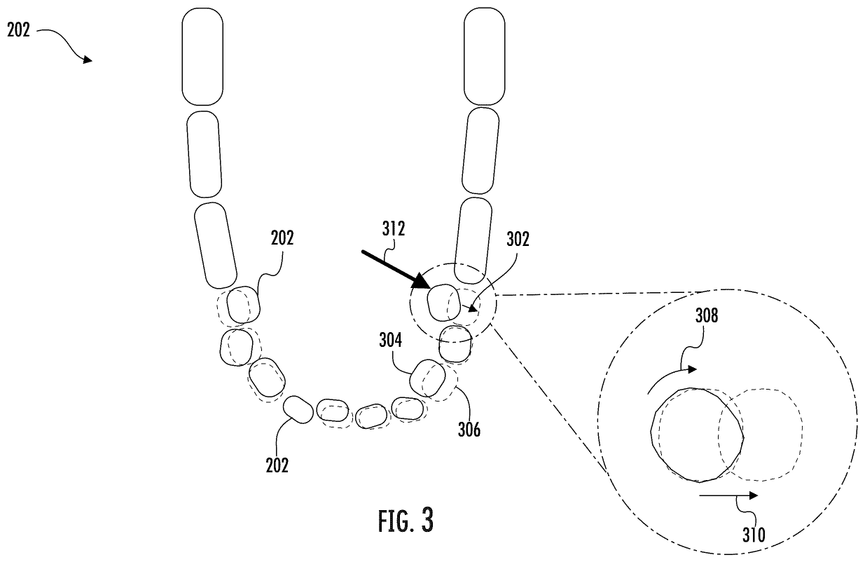

Referring now to FIGS. 1 and 3, the tooth control computing system 100 may be configured to determine a movement of at least one tooth 202. For example, the tooth movement processing engine 108 may be configured to determine a movement 302 of at least one tooth 202. The movement 302 can be based on a treatment plan. For example, a treatment plan may include at least one step to move a patient tooth from a first position 304 to a second position 306. The second position 306 may be a final position or an intermediate position. The treatment plan can have any number steps. Each step may have a corresponding appliance to move the teeth toward the second position 306. Each step may have a corresponding movement 302. Based on the treatment plan, the tooth movement processing engine 108 may determine the movement 302 of the tooth 202. The movement 302 may be for a single step of the treatment plan or for an entire treatment plan with a plurality of steps. For example, the movement 302 may be a movement from a first position 304 to a second position 306, wherein the second position 306 can be an intermediate position or a final position.

The movement 302 may have at least one rotational movement (or vector) 308 and at least one translational movement (or vector) 310. For example, to reach the second position 306, the treatment plan may have the tooth 202 rotating about an axis of the tooth 202. For example, the first position 304 of the tooth 202 may be turned or tilted with respect to the second position 306. To reach the second position 306, the treatment plan may have the tooth 202 sliding along a plane. For example, the tooth 202 may have to translate in a mesial or distal direction or in a lingual or buccal direction. The movement 302 of the tooth 202 can be defined in six degrees of freedom.

Based on the movement 302, the tooth movement processing engine 108 may be configured to determine a force 312 capable of causing the movement 302. For example, the force 312 may cause the tooth 202 to move from the first position 304 to the second position 306. The force 312 may have a magnitude and a direction. The force 312 may include only a pushing force. The force 312 may also include any variation or combination of forces. The direction of the force 312 may be based on the direction of the movement 302. For example, if the movement 302 includes moving the tooth 202 in a distal direction, the force 312 can have a distal direction. The magnitude may be based on the size of the movement 302. For example, a force 312 may be greater for a movement 302 with a greater translational movement 310 than for a movement 302 with a smaller translational movement 310. The tooth movement processing engine 108 may be configured to determine a plurality of forces 312 for a single movement 302. For example, to rotate a tooth 202, a first force 312 may be applied in a first direction at a first edge of the tooth 202 and a second force 312 may be applied in a second direction at an opposing second edge of the tooth 202 to generate a moment about an axis of the tooth 202.

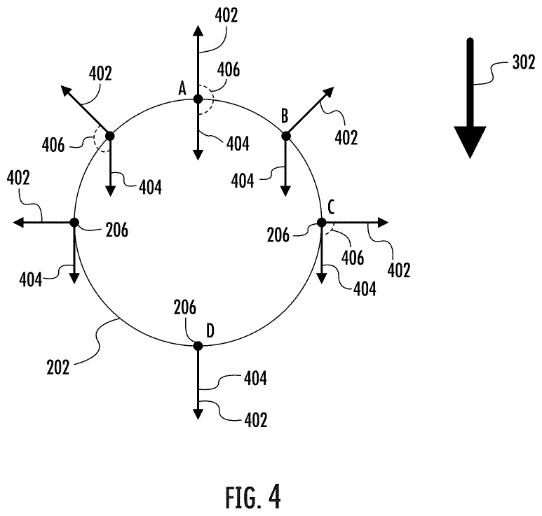

Referring now to FIGS. 1, 4, 5A-5C, and 6, the tooth control computing system 100 may be configured to calculate a factor of engagement (also referred to as an engagement factor). For example, the tooth face processing engine 110 may be configured to calculate a factor of engagement. The factor of engagement may be for an individual tooth face 206. For example, the factor of engagement may identify an ability for a tooth face 206 to receive a force configured to move the tooth 202 from a first position 304 to a second position 306. A greater factor of engagement may indicate better control and predictability of a movement 302. The factor of engagement may consider, for example, pushing forces, pulling forces, or a combination thereof. The factor of engagement may be based, at least partially, on the degree of normality (e.g., angle) of the tooth face 206 with respect to a direction of the movement 302. For example, a first tooth face 206 may be normal (perpendicular) to, or substantially (plus or minus 10%) normal to the direction of the movement 302. The first tooth face 206 may have a high factor of engagement. A second tooth face 206 may be less normal (e.g., at a 45 degree angle) to the direction of the movement 302. The second tooth face 206 may have a lower factor of engagement than the first tooth face 206. A third tooth face 206 may be parallel to, or substantially parallel to the direction of movement 302. The third tooth face 206 may have a low or negligible factor of engagement lower than the first and second tooth faces 206. The tooth face processing engine 110 may be configured to calculate a factor of engagement for a plurality of tooth faces 206. The tooth face processing engine 110 may be configured to determine a tooth factor of engagement based on the factors of engagement for the plurality of tooth faces 206. For example, the tooth face processing engine 110 may be configured to combine (e.g., sum, average) the factors of engagement for the plurality of tooth faces 206 to calculate the tooth factor of engagement. The tooth factor of engagement may identify an ability of the tooth 202 to receive a force 312 configured to cause the movement 302 of the tooth 202.

To calculate the factor of engagement for a tooth face 206, the tooth face processing engine 110 may be configured to calculate a face normalized unit vector 402 for the tooth face 206. The face normalized unit vector 402 may be based on the angle of the tooth face 206. For example, the face normalized unit vector 402 may be normal to the tooth face 206. The tooth face processing engine 110 may also be configured to calculate a movement normalized unit vector 404 for the movement 302 at the tooth face 206. The movement normalized unit vector 404 may be based on the direction of the movement 302. For example, the movement normalized unit vector 404 may be parallel with the direction of the movement 302. The tooth face processing engine 110 may be configured to determine a relative angle 406 between the face normalized unit vector 402 and the movement normalized unit vector 404 of the tooth face 206. For example, the tooth face processing engine 110 may measure the angle or determine a magnitude of a cross product of the normalized unit vectors 402, 404.

The tooth face processing engine 110 may be configured to calculate a factor of engagement for each of the plurality of tooth faces 206 of a tooth 202. For example, the tooth face processing engine 110 may be configured to calculate a face normalized unit vector 402 for each of the plurality of tooth faces 206. The tooth face processing engine 110 may be configured to calculate a movement normalized unit vector 404 for the movement at each of the plurality of tooth faces such that each tooth face 206 has a face normalized unit vector 402 and a corresponding movement normalized unit vector 404. The tooth face processing engine 110 may be configured to determine a relative angle between the face normalized unit vectors 402 of the plurality of tooth faces 206 and the corresponding movement normalized unit vectors 404.

The angle 406 between the face normalized unit vector 402 and the movement normalized unit vector 404 of the tooth face 206 may determine the factor of engagement for the tooth face 206. For example, a tooth face 206 with an angle 406 of 180 degrees between the face normalized unit vector 402 and the movement normalized unit vector 404 (e.g., tooth face A) may indicate the tooth face 206 is oriented normal to movement 302 and is facing in a direction opposite to the movement 302. The force 312 to cause the movement 302 may directly contact a surface of the tooth face 206. This direct contact may correlate with a high factor of engagement. A tooth face 206 with an angle 406 of 135 degrees between the face normalized unit vector 402 and the movement normalized unit vector 404 (e.g., tooth face B) may indicate the tooth face 206 is less normal to the movement 302 than tooth face A. However, the tooth face 206 may still be partially normal to the movement 302 and therefore the force 312 may still be able to contact the tooth face 206. This angled contact may correlate with a lesser factor of engagement than a tooth face 206 with direct contact. A tooth face 206 with an angle 406 of 90 degrees between the face normalized unit vector 402 and the movement normalized unit vector 404 (e.g., tooth face C) may mean the tooth face 206 is less normal to the movement 302 than tooth face A and tooth face B. The angle 406 of 90 degrees may indicate the tooth face 206 is oriented parallel with the movement 302. If ignoring friction, a force 312 may not contact a tooth face 206 that is parallel with the direction of the force 312. However, if considering friction, a parallel force 312 may have some contact with the tooth face 206. The parallel orientation may correlate with a small or negligible factor of engagement for the tooth face 206. A tooth face 206 with an angle 406 of 0 degrees between the face normalized unit vector 402 and the movement normalized unit vector 404 (e.g., tooth face D) may indicate the tooth face 206 is oriented normal to movement 302 and is directed in the same direction as the movement 302. When the force 312 comprises only a pushing force, a normal surface directed in the same direction as the force 312 may have a factor of engagement of zero. While the above examples may focus on pushing forces 312, other forces (e.g., pulling forces) may be considered when determining the factor of engagement for a tooth face 206.

The factor of engagement can be based on any value range. For example, the range of a factor of engagement may be between 0 and 1. A factor of engagement of 1 may indicate a normal orientation of the tooth face 206 with respect to the movement 302 such that a force 312 may be directly applied to the tooth face 206. A factor of engagement of 0 may indicate a parallel orientation of the tooth face 206 with respect to the movement 32 such that the force 312 may not be applied to the tooth face 206. A factor of engagement of 0 can also be applied to any tooth face 206 that faces in the same direction as the movement 302.

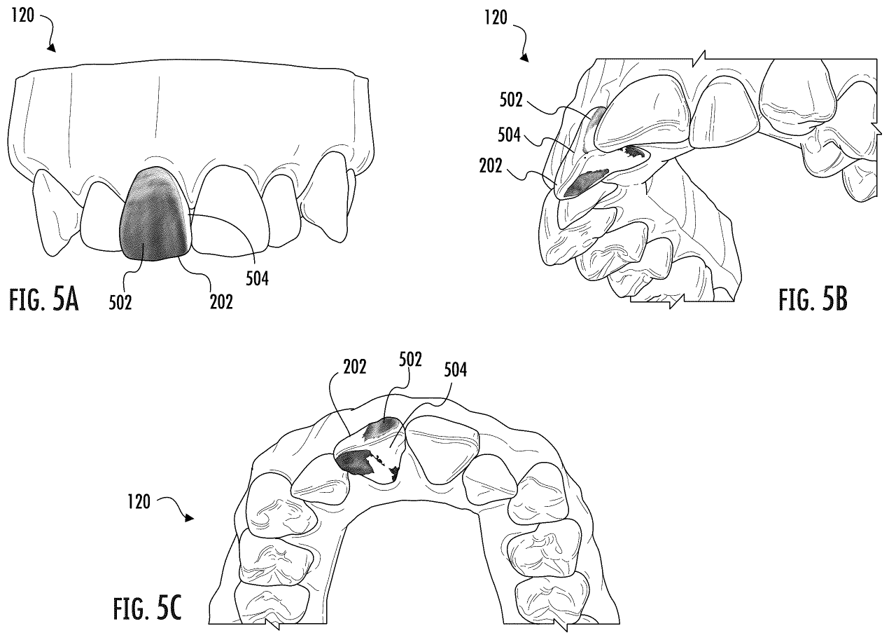

In FIGS. 5A-5C, example visualizations of factors of engagement for a plurality of tooth faces 206 of a tooth 202 are shown, according to exemplary embodiments. A tooth 202 may have one or more addressable tooth faces 502. An addressable tooth face 502 may be configured to receive a force that facilitates the desired movement 302. The tooth 202 may also have one or more unaddressable tooth faces 504. An unaddressable tooth face 504 may be configured such that it cannot receive a force to facilitate the desired movement 302. The non-white surfaces in FIGS. 5A-5C may be addressable tooth faces 502 that have a degree of normality with respect to the direction of the movement 302. For example, the non-white surfaces may be capable of receiving a pushing force to generate the desired movement 302 of the tooth 202. The degree of darkness of the surface of the tooth 202 may correspond with a degree to which the tooth face 206 is normal to the desired translation. For example, the darker the surface, the more normal the tooth face 206 may be. The more normal the tooth face 206, the easier it is to apply a force to the tooth face 206 to generate the intended movement 302. A more normal tooth face 206 may reduce the possibility of slipping and reduce the generation of force components in unintended directions. The lighter the surface, the less normal the tooth face 206 may be to the direction of the movement 302. Some of the tooth faces 206 may be unaddressable tooth faces 504. For example, a dental appliance (e.g., an aligner) may not be able to contact the tooth face 206 or the tooth face 206 may be oriented at an angle that prevents force application on the tooth face 206. An unaddressable tooth face 504 may be shown as white in the visualizations. An unaddressable tooth face 504 may not factor into a controllability of the tooth 202, as described in more detail below.

FIG. 5A shows an example visualization of the factors of engagement for a tooth 202 (e.g., an incisor) when the determined movement 302 of the tooth 202 is to translate in a lingual direction. The darker surfaces of the tooth 202 may include the tooth faces 206 with an orientation more normal to the direction of the movement 302 than the lighter surfaces of the tooth 202. For example, the tooth faces 206 disposed on a front of the tooth may be darker than the tooth faces 206 disposed at or proximate to the side edges of the tooth 202 since the tooth faces 206 of the tooth 202 may angle further away from a normal orientation as the faces 206 get closer to the side edge of the tooth 202. The side of the tooth 202 adjacent to a neighboring tooth 202 may be white because the tooth faces 206 on the side of the tooth 202 may have a low or no degree of normality with respect to the lingual direction of the movement 302. The side of the tooth 202 may also be white because a dental appliance may not be configured to contact the side of the tooth 202. The darker surfaces may have a greater factor of engagement than the lighter surfaces.

FIG. 5B shows an example visualization of the factors of engagement for the tooth 202 when the determined movement 302 of the tooth 202 is to translate in a distal direction. Instead of the darker surfaces being on the face of the first tooth 202, like for the lingual direction, the darker surfaces are on a side of the tooth and on a curved portion of the tooth 202 with tooth faces 206 with a degree of normality with respect to the distal direction of the movement 302. The face of the tooth 202 may be white because the tooth faces 206 on the face are mostly parallel with the direction of movement 302. Portions of the side of the tooth 202 may be white because an adjacent tooth 202 may prevent a force from being applied to certain tooth faces 206 on the side of the tooth 202.

FIG. 5C shows an example visualization of the factors of engagement for the tooth 202 when the determined movement 302 of the tooth 202 is to rotate in a clockwise-direction. To create the rotation, a force can be applied to a right side of the face of the tooth 202 and to a left side of the back of the tooth 202. The right side of the face of the tooth 202 may have darker tooth faces 206 than the left side of the face of the tooth 202 since a force on the left side of the face of the tooth 202 would counteract the clockwise rotation. The left side of the back of the tooth 202 may have darker tooth faces 206 than the right side of the back of the tooth 202 since a force on the right side of the back of the tooth 202 may counteract the clockwise rotation. Furthermore, tooth faces 206 closer to the sides of the tooth 202 may be darker than the tooth faces 206 closer to the center of the tooth 202 since a force near the side of the tooth 202 would generate a greater torque for the clockwise rotation.

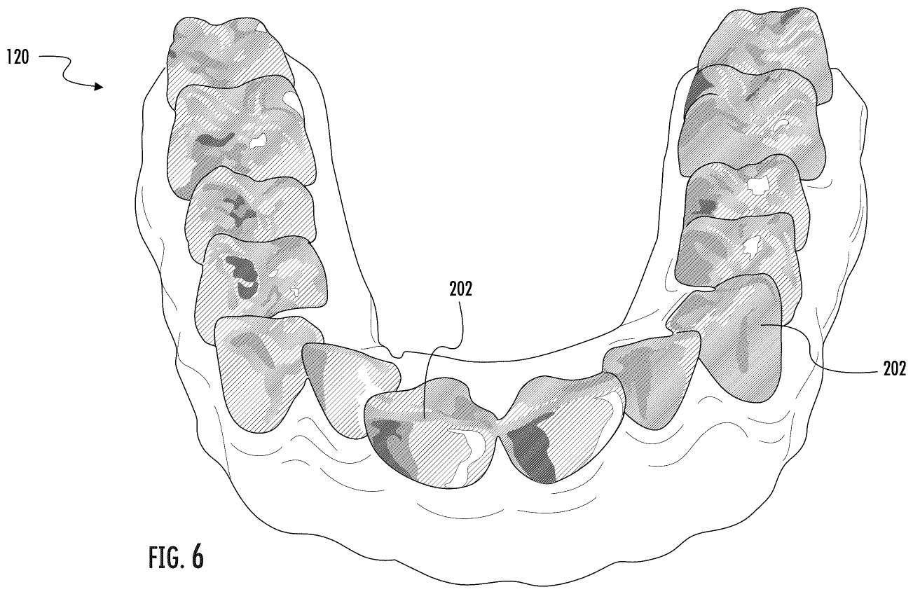

FIG. 6 shows an example visualization of the factors of engagement for a plurality of teeth 202. The tooth face processing engine 110 may be configured to calculate the factor of engagement of each tooth face 206 of each tooth 202. For example, a first tooth may have a first movement 302 and a first geometry. The tooth face processing engine 110 may identify which tooth faces 206 of the first tooth 202 are best oriented (e.g., most normal to the direction of the first movement 302) to receive a first force 312 to generate the first movement 302. A second tooth 202 may have a second movement 302 and a second geometry. The tooth face processing engine 110 may identify which tooth faces 206 of the second tooth 202 are best oriented to receive a second force 312 to generate the second movement 302. The teeth 202 in FIG. 6 illustrate factors of engagement for rotational movements 302. For example, to rotate a tooth 202 a force 312 can be applied away from a center of rotation of the tooth 202 (e.g., center of tooth geometry). Applying a force further away from the center of rotation may create a larger moment force 312. This may be demonstrated by the gradient of darkness going from light to dark about the middle of the teeth 202 when the axis of the center of rotation is the center of the tooth geometry. The tooth faces 206 disposed farthest away from the middle of the tooth 202 may have the highest factor of engagement and be shown as the darkest tooth faces 206.

Referring now to FIGS. 1, 7, and 8A-8B, the tooth control computing system 100 may be configured to determine an addressable area of at least one tooth 202. For example, the tooth face processing engine 110 may be configured to determine an addressable area. The tooth face processing engine 110 may be configured to determine an addressable area for a plurality of teeth 202. The addressable area may include an area of the tooth 202 that can receive a force to aid in achieving the determined movement 302. The addressable area may be based, at least in part, on the factors of engagement of the plurality of tooth faces 206 of the tooth 202. For example, the addressable area may include a subset of the plurality of tooth faces, wherein the subset comprises tooth faces 206 that have a factor of engagement that satisfies a threshold. For example, the threshold may be a factor of engagement greater than zero such that the addressable area may include any tooth face 206 that can receive any amount of force 312. For example, the tooth faces 206 with any degree of normality with respect to the movement 302 and face a direction opposite the direction of the movement 302 may meet the threshold and the tooth faces 206 that are parallel with or face in the same direction as the movement 302 may not meet the threshold. The threshold may also be greater than zero. For example, the factors of engagement may range between 0 and 10. The threshold may indicate that only tooth faces 206 with factors of engagement at or above a 3 may be included in the addressable area. For example, a factor of engagement of 3 or above may be obtained by a tooth face 206 with an angle 406 of at least 120 degrees. Therefore, only tooth faces 206 with an angle 406 of at least 120 (which correlates to a factor of engagement of 3 or greater) is included in the addressable area. Limiting the addressable area to tooth faces 206 with larger factors of engagement may increase the controllability and predictability of the tooth movement 302.

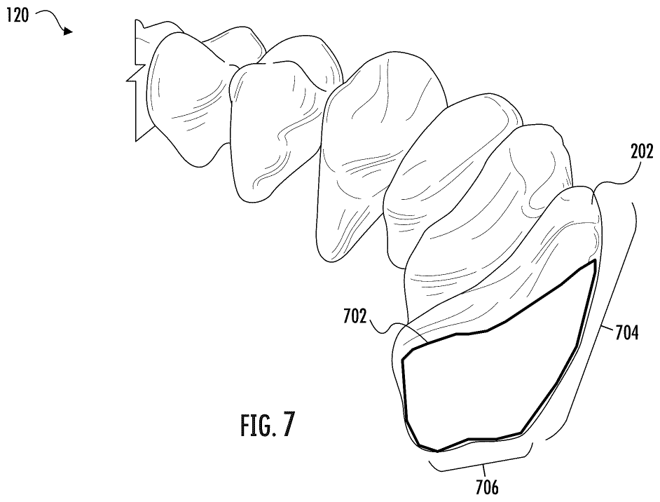

As shown in FIG. 7, the addressable area may be a total addressable area 702. The total addressable area 702 may be the maximum area of the tooth 202 that can receive a force 312 to effectuate the movement 302. The total addressable area 702 may include a subset of the plurality of tooth faces 206 of the tooth 202, wherein the subset includes all of the tooth faces 206 of the tooth 202 that satisfy the engagement factor threshold. For example, the tooth 202 can have a crown 704 and a root 706. Both the crown 704 and the root 706 can have a plurality of tooth faces 206. The tooth faces 206 of both the crown 704 and the root 706 that satisfy the engagement factor threshold may be a part of the total addressable area 702.

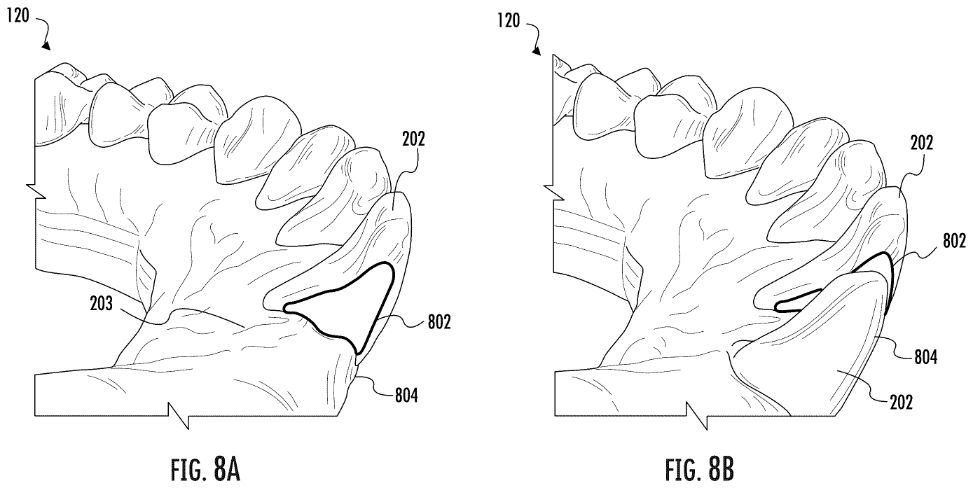

As shown in FIGS. 8A and 8B, the addressable area may be an actual addressable area 802. The actual addressable area 802 may be the area of the tooth 202 that can receive a force 312 despite the presence of an obstruction 804. The obstruction 804 can be any object that can block a tooth face 206 from receiving a force 312. For example, the obstruction 804 may be the gingiva 203. The gingiva 203 may conceal at least a portion of a root 706 of a tooth 202 and prevent a force from being applied to the portion of the root 706. The obstruction 804 may also be another tooth 202. For example, if a force is to be applied to a side of a first tooth 202, a second tooth 202 adjacent to the first tooth 202 may block at least a portion of the side of the first tooth 202 and prevent a force from being applied to the portion of the side of the first tooth 202. The actual addressable area 802 may include a subset of the tooth faces 206 that are a part of the total addressable area 702. For example, a tooth 202 may include a plurality of tooth faces 206. The total addressable area 702 may comprise a first subset of the plurality of tooth faces 206. The first subset may comprise tooth faces that have a factor of engagement that satisfies a threshold. An obstruction 804 may prevent at least one of the tooth faces 206 of the first subset from being able to receive a force 312. For example, a gingiva 203 may prevent tooth faces 206 of the root 706 from receiving a force 312. An adjacent tooth 202 may prevent a portion of the tooth faces 206 of a side of the tooth 202 from receiving a force 312. The actual addressable area 802 may include a second subset of the plurality of tooth faces 206. The second subset can include the tooth faces of the first subset less the tooth faces 206 that are prevented from receiving a force due to the obstruction 804. In other words, the second subset may include the tooth faces of the first subset that can receive the force 312 despite the presence of the obstruction 804.

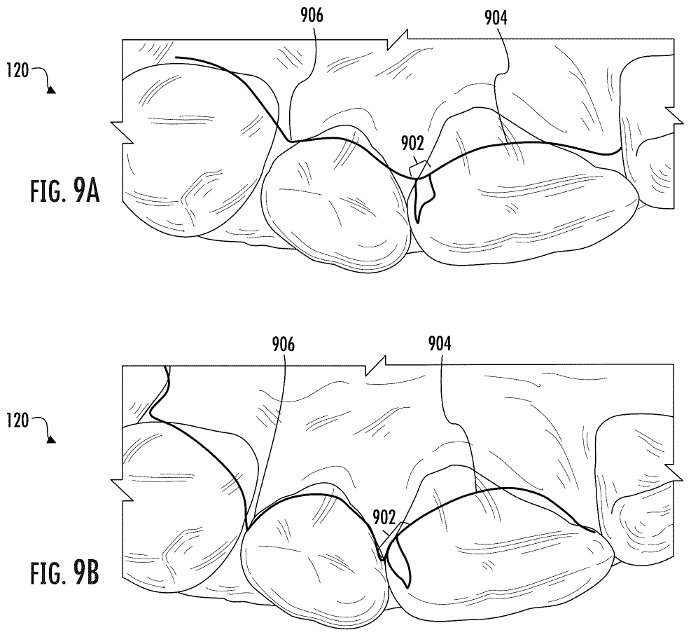

Referring now to FIGS. 1, 9A, and 9B, the tooth control computing system 100 may be configured to identify an area of engagement 902 (or engagement area) of a tooth 202. For example, the tooth face processing engine 110 may be configured to identify an area of engagement 902 of a tooth 202. The tooth face processing engine 110 may be configured to identify an area of engagement for a plurality of teeth 202. The area of engagement 902 can define an area of the tooth 202 that may receive a force 312 from a dental appliance 904 (e.g., a dental aligner). For example, where a dental appliance 904 can apply a force on the tooth 202 to effectuate the determined movement 302 can define the area of engagement 902. The area of engagement 902 may include at least a portion of the actual addressable area 802. The portion can include tooth faces 206 accessible by the dental appliance 904 such that the dental appliance 904 can apply a force 312 to the tooth faces 206. The area of engagement 902 can be based on a geometry of the tooth 202, a geometry of the dental appliance 904, a material of the dental appliance 904, among others, and any combination thereof. For example, as shown in FIGS. 9A and 9B, different geometries of an appliance 904 can change the area of engagement 902. For example, the appliance 904 can have at least one indent 906. The indent 906 can be configured to extend into the interproximal space between two adjacent teeth 202. The appliance 904 in FIG. 9A has a shallower indent 906 than the appliance 904 in FIG. 9B. The shallower indent 906 may contact less of the tooth 202 and have a smaller area of engagement 902. The deeper indent 906 may contact more of the tooth 202 and have a larger area of engagement 902.

The tooth control computing system 100 may be configured to receive appliance data corresponding to the dental appliance 904. For example, the tooth control computing system 100 may receive a digital model 120 of the dental appliance 904 or dimensions of the dental appliance 904. The tooth face processing engine 110 may be configured to apply the appliance data to the digital model 120 of the dentition to determine where the dental appliance 904 may contact a tooth 202. For example, the tooth control computing system 100 may receive a digital model 120 of the dental appliance 904. The tooth control computing system 100 may simulate an interaction between the digital model 120 of the dental appliance 904 and the digital model 120 of the dentition to determine where the dental appliance 904 applies a force on the tooth 202. The tooth control computing system 100 may be configured to identify the portion(s) of the actual addressable area 802 where the dental appliance 904 contacts the tooth 202 as the engagement area 902.

Referring back to FIG. 1, the tooth control computing system 100 may be configured to calculate a controllability score for at least one tooth 202. For example, the controllability scoring engine 112 may be configured to calculate the tooth controllability score. The controllability score may quantify an ability of a dental appliance 904 to control a movement of a tooth 202. The controllability scoring engine 112 may be configured to calculate a controllability score for a plurality of teeth 202. The controllability score may be based, at least partially, on the area of engagement. For example, the controllability scoring engine 112 may calculate the controllability score by determining how much force can be applied to each tooth face 206, including a force vector (also referred to as an available force vector) and a moment vector (also referred to as an available moment vector), and summing up all the force vectors and all the moment vectors. A larger area of engagement comprising more tooth faces 206 may include more vectors to add to get a higher controllability score. The controllability score may also be based, at least partially, on the individual factors of engagement of the tooth faces 206. For example, a tooth face 206 that is normal to the movement 302 may have a greater force vector and moment vector than a tooth face 206 that is not normal to the movement 302. The controllability scoring engine 112 may be configured to combine (e.g., sum, average) the controllability scores for a plurality of teeth 202 to calculate a dentition controllability score. The dentition controllability score may quantify an ability of a dental appliance 904 to control the entire dentition, or at least the plurality of teeth of the dentition that are being moved. The dentition controllability score may be based, at least partially, on the area of engagement for each of the plurality of teeth 202. The dentition controllability score may be the same as or similar to a step controllability score described in more detail below.

The controllability scoring engine 112 may calculate the force and moment vectors of a tooth face 206 by using the following equation:

Fₐ=Fₜ·N

Mₐ=[Mₜ×(P_{f}−Cᵣₒₜ)]·N
N: Normal unit vector of face
Fₜ: Target force unit vector
Cᵣₒₜ: XYZ position of center of rotation
P_{f}: XYZ position of center of face
Mₜ: Target moment unit vector of rotation

The controllability scoring engine 112 may calculate an available force vector for each of the plurality of tooth faces 206 of the area of engagement 902. The controllability scoring engine 112 may calculate an available moment vector for each of the plurality of tooth faces 206 of the area of engagement 902. The controllability scoring engine 112 may calculate the controllability score by summing the available force vectors of all of the tooth faces 206 that are included in the area of engagement 902 and summing the available moment vectors of all the tooth faces 206 that are included in the area of engagement 902.

The controllability scoring engine 112 may also be configured to determine a controllability score for a single step of a treatment plan or of an entire treatment plan. For example, for a step of a treatment plan, the controllability scoring engine 112 may be configured to calculate a plurality of tooth controllability scores, one for each tooth that is being moved during that step. The controllability scoring engine 112 may combine (e.g., sum, average) the plurality of tooth controllability scores to generate a step controllability score. The step controllability score may be a dentition controllability score. For a treatment plan controllability score, the controllability scoring engine 112 may generate a plurality of step controllability scores, one for each step of the treatment plan. The controllability scoring engine 112 may combine the plurality of step controllability scores to generate the treatment plan controllability score.

Still referring to FIG. 1, the tooth control computing system 100 may be configured to generate an output 118. For example, the output processing engine 114 may be configured to generate the output 118. The output 118 may be configured to improve a treatment plan. For example, the tooth control computing system 100 may be configured to increase or improve the area of engagement 902 of a tooth 202. For example, the output processing engine 114 may be configured to adjust or generate an inner geometry of a dental appliance 904 to increase or optimize the area of engagement 902. For example, the tooth control computing system 100 may be configured to receive a model dental appliance 904. The output processing engine 114 may be configured to adjust an area of engagement 902 between the digital model 120 of the dental appliance 904 and the digital model 120 of the dentition by modifying a geometry of the digital model 120 of the dental appliance 904. For example, the output processing engine 114 may identify at least one tooth face 206 that is included in the actual addressable area 802 but is not a part of the engagement area 902. The output processing engine 114 may be configured to generate a new geometry for the dental appliance 904. For example, the output processing engine 114 may be configured to modify the geometry of the digital model 120 of the dental appliance 904. The modification can be based on the size and orientation of the teeth 202 (e.g., amount of space between teeth 202). The modification can also be based on the material of the dental appliance 904. For example, the thickness of the material may determine how deep or how sharp the indent 906 can be.

The controllability scoring engine 112 may be configured to calculate a new controllability score based on the modified geometry of the dental appliance 904. The new controllability score may be greater than the previous controllability score. The output processing engine 114 may also be configured to determine force and/or moment application sites for each tooth 202 to increase or optimize the effectiveness of the force and/or moment applied to the tooth 202. For example, the output processing engine 114 may determine that applying a first force 312 at a first tooth face 206 is more effective than applying the first force 312 at a second tooth face 206. The new geometry of the dental appliance 904 or the application sites determined by the output processing engine 114 may be applied to the digital model 120 via the digital model processing engine 106 to determine an updated controllability score based on the new geometry.

In some embodiments, the output processing engine 114 may be configured to improve a treatment plan by selecting movements that improve a step controllability score and selecting a plurality of steps that improve a treatment plan controllability score. For example, the output processing engine 114 may prioritize sequencing of tooth movements 302 based, at least partially, on an area of engagement 902. For example, the output processing engine 114 may prioritize moving a tooth 202 in a mesial/distal direction before moving the tooth 202 in a buccal/lingual direction because there is a greater area of engagement 902 for the mesial/distal movement 302 before the tooth 202 is aligned with an adjacent tooth due to the buccal/lingual movement.

In some embodiments, the output processing engine 114 may be configured to determine whether a movement is possible. For example, the output processing engine 114 may be configured to compare a tooth controllability score of a tooth 202 that is based on a movement 302 with a predetermined threshold. The threshold may indicate whether a tooth movement 302 is possible. The output processing engine 114 may determine the movement 302 is possible when the controllability score is above the predetermined threshold. The output processing engine 114 may determine the movement 302 is not possible when the controllability score is below the predetermined threshold.

In some embodiments, the output processing engine 114 may be configured to calculate a predictability score. The predictability score may be based, at least partially, on the controllability score. The predictability score may indicate the likelihood that a tooth 202 or a plurality of teeth 202 move as predicted. For example, movement 302 may be a predicted movement for a tooth 202. The controllability scoring engine 112 may be configured to determine a tooth controllability score of the tooth 202. The more controllable the tooth 202, the more predictable the movement 302 may be. For example, the better control a dental appliance 904 has on the tooth 202, the more likely it may be that the dental appliance 904 moves the tooth 202 to a desired position. With the predictability score, the output processing engine 114 may be configured to precisely characterize treatment difficulty and assess efficacy of different appliance designs.

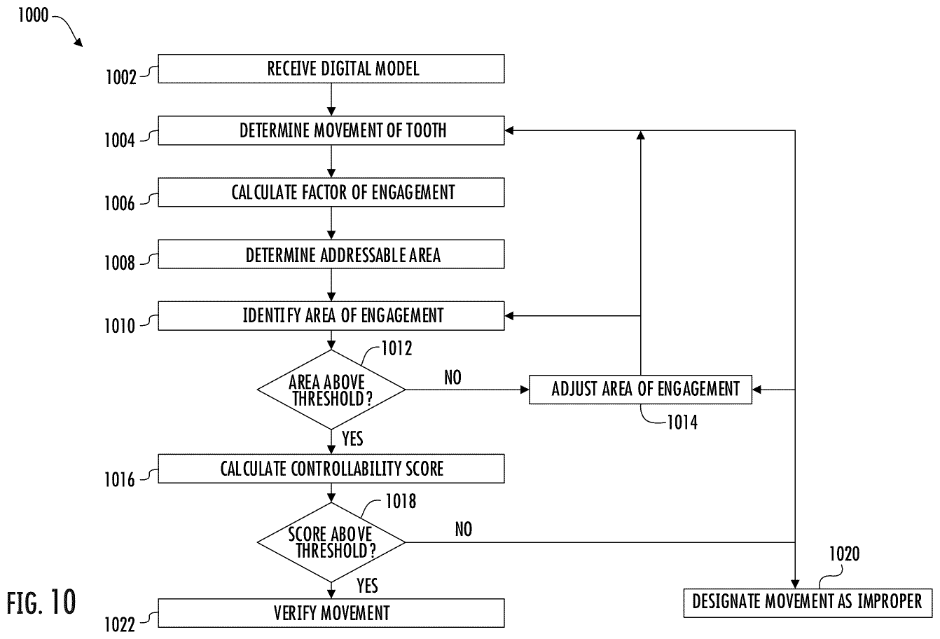

Referring now to FIG. 10, a method 1000 of determining tooth control is shown, according to an exemplary embodiment. Method 1000 may include receiving a digital model (step 1002), determining a tooth movement (step 1004), calculating a factor of engagement (step 1006), determining an addressable area (step 1008), identifying an area of engagement (step 1010), and comparing the area of engagement with an engagement area threshold (step 1012). If the area of engagement is below an engagement area threshold, method 1000 may include adjusting the area of engagement (step 1014). If the area of engagement is at or above the engagement area threshold, the method 1000 may include calculating a controllability score (step 1016).

At step 1002, one or more processors may receive a digital model 120. The digital model 120 may be of a dentition. For example, the digital model processing engine 106 may receive the digital model 120. The digital model 120 may include at least one tooth 202. The tooth 202 may have a tooth mesh 204 defining a plurality of tooth faces 206 or the digital model processing engine 106 may generate a tooth mesh 204 for the tooth 202. The digital model 120 may include a plurality of teeth 202. The plurality of teeth 202 may have a tooth mesh 204 defining a plurality of tooth faces 206 or the digital model processing engine 106 may generate a tooth mesh 204 for the plurality of teeth 202. The digital model processing engine 106 may receive the digital model 120 with the tooth 202 in an initial (or first) position 304.

At step 1004, one or more processors may determine a movement 302 of a tooth 202. For example, the tooth movement processing engine 108 may determine a movement 302 of at least one tooth 202. The movement 302 may be a path the tooth 202 follows to move from the first position 304 to a second position 306. For example, the movement 302 may cause the tooth 202 to be in better alignment with surrounding teeth 202. The movement 302 may include a rotational vector 308 and a translational vector 310. The movement 302 may be based on a treatment plan. The treatment plan may be a predetermined treatment plan, or the tooth movement processing engine 108 may establish the treatment plan. For example, the tooth movement processing engine 108 may identify a tooth 202 that is not aligned with other teeth 202 of the dentition and identify a movement 302 to make the tooth 202 more aligned with the others. Determining the movement 302 may include calculating a force 312 to cause the movement 302. The force 312 may include only a pushing force. The force 312 may include a magnitude and a direction. The tooth movement processing engine 108 may calculate a plurality of forces 312 to cause the movement 302. The forces 312 calculated may be based on the movement 302 and the shape of the tooth 202.

At step 1006, one or more processors may calculate a factor of engagement. For example, the tooth face processing engine 110 may calculate a factor of engagement. The tooth face processing engine 110 may calculate a factor of engagement for a plurality of tooth faces 206 of a tooth 202. The factor of engagement may identify an ability for a tooth face 206 to receive a force configured to move the tooth 202 from a first position 304 to a second position 306. The factor of engagement may be based, at least partially, on the degree of normality (e.g., angle) of the tooth face 206 with respect to the direction of the movement 302. To calculate the factor of engagement of a tooth face 206, the tooth face processing engine 110 may calculate a face normalized unit vector 402 and a corresponding movement normalized unit vector 404 for the tooth face 206. The face normalized unit vector 402 may be based on an orientation of the tooth face 206. The movement normalized unit vector 404 may be based on the direction of the movement 302. The tooth face processing engine 110 may determine an angle 406 between the face normalized unit vector 402 and the movement normalized unit vector 404. The factor of engagement may be based, at least partially, on the angle 406.

At step 1008, one or more processors may determine an addressable area. For example, tooth face processing engine 110 may determine an addressable area. The addressable area may be a total addressable area 702. Determining the total addressable area 702 may include establishing a threshold factor of engagement. The threshold factor of engagement may indicate whether a tooth face 206 can be a part of the total addressable area. The total addressable area 702 may include any tooth face 206 that has a factor of engagement that satisfies the threshold factor of engagement. For example, the tooth 202 may include a plurality of tooth faces 206. The tooth face processing engine 110 may identify a first subset of the plurality of tooth faces that have a factor of engagement that satisfies the threshold factor of engagement. The total addressable area may include the first subset of the plurality of tooth faces 206.

Step 1008 may also include determining an actual addressable area 802. Determining the actual addressable area 802 may include detecting or identifying an obstruction 804 that prevents at least one of the tooth faces 206 of the first subset from being able to receive a force 312. For example, the tooth face processing engine 110 may identify an adjacent tooth 202 that prevents at least one tooth face 206 on a side of the tooth 202 that is a part of the total addressable area 702 from receiving a force 312 (e.g., a dental appliance cannot contact the tooth face 206). Determining the actual addressable area 802 may include identifying a second subset of the plurality of tooth faces 206 of the tooth 202 that includes the tooth faces 206 of the first subset that can receive a force 312 despite the presence of the obstruction 804.

At step 1010, one or more processors may identify an area of engagement of at least one tooth. For example, the tooth face processing engine 110 may identify an area of engagement 902 of at least one tooth 202. The area of engagement 902 may include at least a portion of the actual addressable area 802. For example, the area of engagement 902 may include the portion of the actual addressable area 802 that includes tooth faces 206 that are accessible by a dental appliance 904 to apply a force 312. Identifying the area of engagement 902 may include comparing a shape of a dental appliance 904 with the geometry of the tooth 202 and identifying which parts of the tooth 202 that are a part of the actual addressable area 802 can contact the dental appliance 904. Comparing the dental appliance 904 with the geometry of the tooth 202 may include simulating an interaction between a digital model 120 of the dentition and a digital model 120 of the dental appliance 904.

At step 1012, one or more processors may compare the area of engagement 902 to an engagement area threshold. The engagement area threshold may indicate whether the area of engagement 902 can be or should be increased. For example, the engagement area threshold may be a maximum amount of the actual addressable area 802 that a dental appliance 904 can contact if reshaped (e.g., maximize area of engagement by modifying geometry of the appliance 904). The engagement area threshold may be a percentage of the actual addressable area (e.g., the area of engagement is at least 50% of the actual addressable area). The tooth face processing engine 110 may determine whether the area of engagement 902 is above or below the engagement area threshold.

When the area of engagement is below the engagement area threshold, at step 1014, the output processing engine 114 may adjust the area of engagement by modifying the geometry of the dental appliance 904. For example, the tooth face processing engine 110 may determine that a dental appliance 904 with an initial geometry creates a first area of engagement 902. The output processing engine 114 may determine that the first are of engagement is less than the engagement area threshold (e.g., that the first area of engagement 902 is less than 50% of the actual addressable area 802). The output processing engine 114 may modify the initial geometry of the dental appliance 904 to create a second geometry. The output processing engine 114 may consider the material of the dental appliance 904 and any obstructions 804 surrounding the tooth, among other factors, when creating the second geometry. The tooth face processing engine 110 may determine the dental appliance 904 with the second geometry creates a second area of engagement 902. The second area of engagement 902 may be larger than the first area of engagement 902 (e.g., 75% of the actual addressable area). The second area of engagement 902 may still be smaller than the actual addressable area 802. Identifying the area of engagement and adjusting the area of engagement may be an iterative process. If it is not possible to create an area of engagement 902 that satisfies the engagement area threshold, method 1000 may return back to step 1004 and determine a different movement 302 for the tooth 202.

When the area of engagement is at or above the engagement area threshold, at step 1016, one or more processors may calculate a controllability score at step 1016. For example, the controllability scoring engine 112 may calculate a controllability score. The controllability score can be a tooth controllability score for at least one tooth 202, a dentition or step controllability score for a plurality of teeth 202, or a treatment plan controllability score. The controllability score may be based, at least partially, on the area of engagement of a tooth 202. The tooth controllability score may quantify an ability of a dental appliance 904 to control a movement of a single tooth 202. The dentition or step controllability score may quantify an ability of a dental appliance 904 to control a plurality of teeth 202 of a dentition during a single step of a treatment plan (e.g., application of a single dental appliance 904 to the dentition). The treatment plan controllability score may quantify an ability of a treatment plan (e.g., more than one step) to control movements of at least one tooth 202. The controllability scoring engine 112 may output the calculated controllability score.

Calculating a tooth controllability score may include calculating an available force vector for each of the plurality of tooth faces 206 of a tooth 202 within an area of engagement 902, calculating an available moment vector for each of the plurality of tooth faces 206 within the area of engagement 902, and summing the available force vectors and summing the available moment vectors. The available force vectors and available moment vectors can indicate an amount of force or moment a tooth face 206 can receive to assist in moving the tooth 202 from a first position 304 to a second position 306. The more force or moment the tooth faces 206 of the area of engagement 902 can receive, the more control the dental appliance 904 may have on the tooth 202. Calculating a step (or dentition) controllability score may include combining (e.g., summing, averaging) tooth controllability scores for the teeth 202 of the dentition that are being moved in the step. Therefore, the step/dentition controllability score may be based, at least partially, on the area of engagement for each of the plurality of teeth 202 being moved. The controllability scoring engine 112 may calculate a step controllability score for each step of a treatment plan. For example, calculating a step controllability score may include performing steps 1004-1016 for each tooth 202 that is being moved in the step. Calculating the treatment plan controllability score may include combining (e.g., summing, averaging) the step controllability scores for each step of the treatment plan. The treatment plan controllability score may indicate an overall potential effectiveness of the treatment plan.

At step 1018, one or more processors may compare the calculated controllability score with a controllability threshold. For example, the output processing engine 114 may compare the calculated controllability score with the controllability threshold. The controllability threshold may determine whether the tooth movement, the step, or the treatment plan is possible. For example, the output processing engine 114 may compare a tooth controllability score with a tooth controllability threshold. The output processing engine 114 may determine the movement 302 of the tooth 202 is possible when the tooth controllability score is at or above the tooth controllability threshold. The output processing engine 114 may determine the movement 302 of the tooth 202 is not possible when the tooth controllability score is below the tooth controllability threshold. The output processing engine 114 may generate an output based on whether the movement 302 is possible.

Steps 1016 and 1018 may also include calculating a predictability score and comparing the predictability score with a predictability threshold. The predictability score may indicate how likely it is that the tooth 202/teeth 202 will be moved according to the determined movement 302. The predictability score may be correlated with the controllability score. For example, a greater controllability score may increase the predictability score. The predictability score may provide a mechanism to precisely characterize treatment difficulty and assess efficacy of different appliance designs. Similar to the controllability score, the predictability score may be compared to a predictability threshold. The comparison may indicate whether the movement is proper or improper.

When the controllability score is below the controllability threshold (or the predictability score is below the predictability threshold), the output processing engine 114 may cause method 1000 to either return to step 1004 and determine a new movement for the tooth 202, return to step 1012 and adjust the area of engagement (if not already optimized), or proceed to step 1020 and designate the movement as improper. A designation as improper may indicate that the dental appliance 904 would not have enough control of the tooth to effectuate the movement 302 and move the tooth to the desired position. The output processing engine 114 may designate the movement as improper after attempting to adjust the area of engagement and trying different movements and no iteration has led to a proper movement.

When the controllability score is at or above the controllability threshold, at step 1022, the output processing engine 114 may verify the movement 302. Verifying the movement may include verifying a preexisting treatment plan, generating a new treatment plan with the verified movement 302, approving a predetermined dental appliance geometry, generating a new dental appliance geometry to effectuate the verified movement 302, among others.

For example, if the movement 302 is not possible, the output processing engine 114 may modify a geometry of a dental appliance to increase the area of engagement to increase the tooth controllability score. The output processing engine 114 may also generate a new treatment plan such that a first movement of a tooth 202 may create a greater actual addressable area 802 for a second movement of the tooth 202.

Method 1000, including at least some of the steps, may be repeated any number of times. For example, method 1000 may be used for a plurality of movements 302 for at least one tooth in order to generate a treatment plan. For example, at step 1004, one or more processors may determine a plurality of movements 302 for at least one tooth 202. The plurality of movements 302 may be based on a treatment plan, wherein each of the plurality of movements 302 corresponds with a step of the treatment plan. At step 1016, the one or more processors may calculate a treatment plan controllability score based on the plurality of movements 302 of at least one tooth 202. For example, the one or more processors may calculate a step controllability score for each step of the treatment plan based on the corresponding movement 302 and then combine (e.g., sum, average) the step controllability scores to generate the treatment plan controllability score. At step 1018, the one or more processors may determine whether the treatment plan controllability score is above or below a threshold. If below the threshold, the one or more processors may adjust a movement or geometry of a dental appliance 904 or designate the treatment plan as improper. If at or above the threshold, the one or more processors may verify the treatment plan.

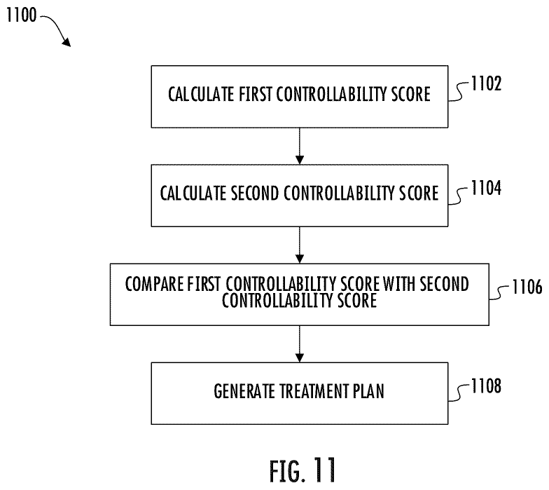

Referring now to FIG. 11, a method 1100 of generating a treatment plan is shown, according to an exemplary embodiment. Generating a treatment plan may include, for example, selecting a treatment plan from predetermined treatment plans or generating a treatment plan step by step. Method 1100 may include calculating a first controllability score (step 1102), calculating a second controllability score (step 1104), comparing the first and second controllability scores (step 1106), and generating a treatment plan (step 1108).

At step 1102, one or more processors may calculate a first controllability score. For example, the controllability scoring engine 112 may calculate the first controllability score. Calculating the first controllability score may include at least some of the steps of method 1000. The first controllability score may be a first treatment plan controllability score. For example, a tooth movement processing engine 108 may determine a first step one movement 302 of at least one tooth 202. The first step one movement 302 may be based on a first treatment plan. For example, the first step one movement 302 may be the movement 302 of the tooth 202 during step one of the first treatment plan. The tooth movement processing engine 108 may also determine a first step two movement 302 of the at least one tooth 202. The first step two movement 302 may also be based on the first treatment plan. For example, the first step two movement 302 may be the movement 302 of the tooth 202 during step two of the first treatment plan. The controllability scoring engine 112 may calculate a first controllability score of the first treatment plan based on the first step one movement and the first step two movement.

At step 1104, the same steps may be performed for a second treatment plan. For example, one or more processors may calculate a second controllability score. For example, the controllability scoring engine 112 may calculate the second controllability score. Calculating the second controllability score may include some of the steps of method 1000. The second controllability score may be a second treatment plan controllability score. For example, a tooth movement processing engine 108 may determine a second step one movement 302 of at least one tooth 202. The second step one movement 302 may be based on the second treatment plan. The tooth movement processing engine 108 may also determine a second step two movement 302 of the at least one tooth 202. The second step two movement 302 may also be based on the second treatment plan. The controllability scoring engine 112 may calculate a second controllability score of the second treatment plan based on the second step one movement and the second step two movement.

At step 1106, one or more processors may compare the first controllability score with the second controllability score. For example, the first controllability score of the first treatment plan may be different than the second controllability score of the second treatment plan due to the first step one movement 302 and the first step two movement 302 being different from the second step one movement and the second step two movement 302. A higher treatment plan controllability score may indicate a better control of the teeth 202 that are being moved during the treatment plan, which may indicate a more predictable result.

At step 1108, one or more processors may generate a treatment plan based on the comparison of the first and second controllability scores. Generating a treatment plan may include selecting one of the preexisting treatment plans. For example, the output processing engine 114 may select at least one of the first and second treatment plans based on the comparison of the first and second treatment plan controllability scores. For example, the output processing engine 114 may select the treatment plan that has the higher controllability score.

Referring back to the beginning of method 1100, to generate a treatment plan step by step, at step 1102 one or more processors may calculate a first controllability score that is a first step one controllability score. The first step one controllability score may be for a single tooth 202 or for a plurality of teeth 202. For example, the tooth control computing system 100 may receive a digital model 120 of a dentition, wherein the digital model 120 includes a plurality of teeth 202. A tooth movement processing engine 108 may determine a movement 302 for each of the plurality of teeth 202. The controllability scoring engine 112 may calculate a first step one controllability score based on the movements for each of the plurality of teeth 202 (e.g., calculate a tooth controllability score for each of the plurality of teeth 202 and combine the plurality of tooth controllability scores).

At step 1104, the same steps may be performed to an alternative movement 302 for the plurality of teeth 202. The controllability scoring engine 12 may calculate a second step one controllability score based on the alternative movements for the plurality of teeth 202. All of the teeth 202 can have an alternative movement 302, or just a subset of the plurality of teeth 202 may have an alternative movement 302. The controllability scoring engine 112 may calculate a second step one controllability score based on the alternative movements for the plurality of teeth 202.

At step 1106, one or more processors may compare the first step one controllability score with the second step one controllability score. At step 1108, one or more processors may generate a treatment plan based on the comparison of the first and second step one controllability scores. For example, the output processing engine 114 may select the movements or the alternative movements to create the first step of a treatment plan based on the comparison of the controllability scores. Method 1100 may be repeated any number of times to generate any number of steps for a treatment plan. For example, when step one is decided to include the alternative movements 302, the tooth control computing system 100 may determine a step two movement and a step two alternative movement, and calculate a first step two controllability score and a second step two controllability score to compare to determine a step two of the treatment plan.

The embodiments described herein have been described with reference to drawings. The drawings illustrate certain details of specific embodiments that provide the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As utilized herein, terms of degree such as “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to any precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that terms such as “exemplary,” “example,” and similar terms, as used herein to describe various embodiments, are intended to indicate that such embodiments are possible examples, representations, or illustrations of possible embodiments, and such terms are not intended to connote that such embodiments are necessarily extraordinary or superlative examples.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any element on its own or any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the drawings. It should be noted that the orientation of various elements may differ according to other exemplary embodiments, and that such variations are intended to be encompassed by the present disclosure.

As used herein, terms such as “engine” or “circuit” may include hardware and machine-readable media storing instructions thereon for configuring the hardware to execute the functions described herein. The engine or circuit may be embodied as one or more circuitry components including, but not limited to, processing circuitry, network interfaces, peripheral devices, input devices, output devices, sensors, etc. In some embodiments, the engine or circuit may take the form of one or more analog circuits, electronic circuits (e.g., integrated circuits (IC), discrete circuits, system on a chip (SOCs) circuits, etc.), telecommunication circuits, hybrid circuits, and any other type of circuit. In this regard, the engine or circuit may include any type of component for accomplishing or facilitating achievement of the operations described herein. For example, an engine or circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

An engine or circuit may be embodied as one or more processing circuits comprising one or more processors communicatively coupled to one or more memory or memory devices. In this regard, the one or more processors may execute instructions stored in the memory or may execute instructions otherwise accessible to the one or more processors. The one or more processors may be constructed in a manner sufficient to perform at least the operations described herein. In some embodiments, the one or more processors may be shared by multiple engines or circuits (e.g., engine A and engine B, or circuit A and circuit B, may comprise or otherwise share the same processor which, in some example embodiments, may execute instructions stored, or otherwise accessed, via different areas of memory).

Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be provided as one or more suitable processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given engine or circuit or components thereof may be disposed locally (e.g., as part of a local server, a local computing system, etc.) or remotely (e.g., as part of a remote server such as a cloud based server). To that end, engines or circuits as described herein may include components that are distributed across one or more locations.

An example system for providing the overall system or portions of the embodiments described herein might include one or more computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

Although the drawings may show and the description may describe a specific order and composition of method steps, the order of such steps may differ from what is depicted and described. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions, and arrangement of the embodiments without departing from the scope of the present disclosure as expressed in the appended claims.

What is claimed is:

1. A method comprising:
receiving, by one or more processors, a digital model of a dentition, the digital model comprising at least one tooth comprising a plurality of tooth faces;
determining, by the one or more processors, a factor of engagement for each of the plurality of tooth faces based on a degree of normality of each tooth face with respect to a direction of a movement for the at least one tooth;
determining, by the one or more processors, an addressable area of the at least one tooth based on the factors of engagement of the plurality of tooth faces, wherein the addressable area comprises at least one of the plurality of tooth faces, wherein the factor of engagement for each tooth face in the at least one of the plurality of tooth faces satisfies a threshold;
identifying, by the one or more processors, an area of engagement of the at least one tooth, wherein the area of engagement comprises at least a portion of the addressable area, the portion comprising at least one tooth face accessible by a dental appliance to apply a force to the at least one tooth to effectuate the movement;
outputting, by the one or more processors, a controllability score for the at least one tooth based on the area of engagement.

2. The method of claim 1, further comprising selecting the movement for a treatment plan configured to move the at least one tooth from an initial position to a final position based on the controllability score.

3. The method of claim 1, wherein determining the factor of engagement for each of the plurality of tooth faces comprises:
determining, by the one or more processors, a face normalized unit vector for each of the plurality of tooth faces;
determining, by the one or more processors, a movement normalized unit vector for each of the plurality of tooth faces; and
determining, by the one or more processors, a relative angle between the face normalized unit vector and the movement normalized unit vector for each tooth face.

4. The method of claim 1, wherein the addressable area is an actual addressable area, and determining the actual addressable area comprises:
determining, by the one or more processors, a total addressable area, wherein the total addressable area comprises a first subset of the plurality of tooth faces of the at least one tooth, wherein the factors of engagement of the first subset of the plurality of tooth faces satisfy the threshold;
identifying, by the one or more processors, an obstruction that prevents at least one of the plurality of tooth faces of the first subset from being able to receive the force; and
determining, by the one or more processors, the actual addressable area, wherein the actual addressable area comprises the at least one tooth face, wherein the at least one tooth face is capable of receive the force despite the obstruction.

5. The method of claim 1, wherein outputting the controllability score comprises:
determining, by the one or more processors, an available force vector for the at least one tooth face within the area of engagement;
determining, by the one or more processors, an available moment vector for the at least one tooth face within the area of engagement; and
summing, by the one or more processors, the available force vectors and the available moment vectors.

6. The method of claim 1, wherein the controllability score is a first controllability score, the method further comprising:
receiving, by the one or more processors, a model dental appliance;
adjusting, by the one or more processors, the area of engagement by modifying a geometry of the model dental appliance; and
determining, by the one or more processors, a second controllability score for the at least one tooth based on the adjusted area of engagement, wherein the second controllability score is greater than the first controllability score.

7. The method of claim 1, further comprising:
receiving, by the one or more processors, the digital model of the dentition, the digital model comprising a plurality of teeth;
identifying, by the one or more processors, the area of engagement for each of the plurality of teeth; and
determining, by the one or more processors, a dentition controllability score based on the area of engagement for each of the plurality of teeth.

8. The method of claim 1, further comprising:
receiving, by the one or more processors, the digital model of the dentition, the digital model comprising a plurality of teeth;
determining, by the one or more processors, a movement for at least one tooth of the plurality of teeth;
outputting, by the one or more processors, a first controllability score based on the movement of the at least one tooth;
determining, by the one or more processors, an alternative movement for the at least one tooth;
outputting, by the one or more processors, a second controllability score based on the alternative movement for the at least one tooth.

9. The method of claim 8, further comprising:
comparing, by the one or more processors, the first controllability score and the second controllability score; and
generating, by the one or more processors, a step of the treatment plan based on the comparison of the first controllability score and the second controllability score.

10. The method of claim 1, further comprising:
determining, by the one or more processors, a plurality of movements for the at least one tooth based on the treatment plan, wherein each of the plurality of movements corresponds with a step of the treatment plan;
determining, by the one or more processors, a treatment plan controllability score based on the plurality of movements for the at least one tooth.

11. The method of claim 1, further comprising determining a pushing force configured to move the at least one tooth from a first position to a second position.

12. A method comprising:
identifying, by one or more processors, an area of engagement of at least one tooth represented in a digital model of a dentition for applying a first force to move the at least one tooth according to a first movement as part of a treatment plan or a second force to move the at least one tooth according to a second movement as part of the treatment plan, wherein the treatment plan is configured to move the at least one tooth from an initial position to a final position, and wherein the area of engagement comprises a portion of the at least one tooth that is capable of engaging with a dental aligner to be manufactured to apply the first force or the second force to the at least one tooth via the area of engagement to move the at least one tooth;
determining, by the one or more processors, a first controllability score for the first movement and a second controllability score for the second movement based on the area of engagement, the first force associated with the first movement, and the second force associated with the second movement; and
selecting, by the one or more processors, the first movement for the treatment plan based on the first controllability score and the second controllability score.

13. The method of claim 12, wherein the first movement is selected for the treatment plan based on the first controllability score exceeding the second controllability score.

14. The method of claim 12, further comprising:
determining, by the one or more processors, a third controllability score for a third movement subsequent to the first movement; and
determining, by the one or more processors, a fourth controllability score for a fourth movement subsequent to the second movement;
wherein the first movement is selected for the treatment plan based on a summation of the first controllability score and the third controllability score exceeding a summation of the second controllability score and the fourth controllability score.

15. The method of claim 12, wherein the at least one tooth is a first tooth, and wherein the first movement is selected for the treatment plan based on a controllability score of a movement selected to be applied to a second tooth represented in the digital model of the dentition.

16. A system comprising:
one or more processors; and
a memory coupled with the one or more processors, wherein the memory stores instructions that, when executed by the one or more processors, cause the one or more processors to:
identify an area of engagement of at least one tooth represented in a digital model of a dentition for applying a first force to move the at least one tooth according to a first movement as part of a treatment plan or a second force to move the at least one tooth according to a second movement as part of the treatment plan, wherein the treatment plan is configured to move the at least one tooth from an initial position to a final position, and wherein the area of engagement comprises a portion of the at least one tooth that is capable of engaging with a dental aligner to be manufactured to apply the first force or the second force to the at least one tooth via the area of engagement to move the at least one tooth;
determine a first controllability score for the first movement and a second controllability score for the second movement based on the area of engagement, the first force associated with the first movement, and the second force associated with the second movement; and
select the first movement for the treatment plan based on the first controllability score and the second controllability score.

17. The system of claim 16, wherein the first movement is selected for the treatment plan based on the first controllability score exceeding the second controllability score.

18. The system of claim 16, wherein the memory further stores instructions that, when executed by the one or more processors, cause the one or more processors to:
determine a third controllability score for a third movement subsequent to the first movement; and
determine a fourth controllability score for a fourth movement subsequent to the second movement;
wherein the first movement is selected for the treatment plan based on a summation of the first controllability score and the third controllability score exceeding a summation of the second controllability score and the fourth controllability score

19. The system of claim 18, wherein the second controllability score exceeds the first controllability score.

20. The system of claim 16, wherein the at least one tooth is a first tooth, and wherein the first movement is selected for the treatment plan based on a controllability score of a movement selected to be applied to a second tooth represented in the digital model of the dentition.
